(19) United States
(12) Patent Application Publication
(10) Pub. No.: US 2026/0112227 A1
(43) Pub. Date: Apr. 23, 2026

(54) SYSTEMS AND METHODS FOR OPERATING DISTRIBUTED SYSTEMS

(71) Applicant: Innovative Vending Solutions LLC, Clayton, NJ (US)

(72) Inventors: Richard Ruggiero, Sewell, NJ (US); James Vassallo, Vineland, NJ (US)

(21) Appl. No.: 18/921,684

(22) Filed: Oct. 21, 2024

(51) Int. Cl. G07F 9/00; G06F 16/25; G07F 9/02

(52) U.S. Cl. CPC G07F 9/002; G06F 16/254; G07F 9/023

(57) ABSTRACT

Systems and methods for operating a computing system. The methods comprise: receiving metadata for a data warehouse (DW) that comprises data identifiers (DIs) each being associated with a unique data item; receiving, from data sources respectively via APIs, datasets that each comprise DI(s) (wherein each dataset has a data format different than data formats of all other datasets); transforming the data format of at least a portion of each dataset into another data format based on the DI(s) and/or a respective API; storing, in interconnected tables within DW, the datasets after said transforming; receiving, through each second API, a request for data (the request comprising DI(s)); and returning, via each second API, analyzed or summarized data based on DI(s) contained in the request and/or a respective second API.

### BACKGROUND

Vending systems are provided at various public sites (such as malls) to provide vending services to individuals. These vending systems include, but are not limited to, massage chairs, kiosk stroller systems, and/or snack vending machines. These vending systems often include a relatively large number of devices distributed across a relatively large geographic area (e.g., across many states and/or countries). As such, data collection, data analytics, and system management are relatively complex, inefficient, resource intensive and costly.

An Enterprise Data Warehouse (EDW) is a system used for reporting and data analysis and is considered a core component of business intelligence. Data warehouses are central repositories of integrated data from one or more disparate sources. They store current and historical data in one single place that is used for creating reports. This is beneficial for companies as it enables them to interrogate and draw insights from their data and make decisions, among other capabilities. However, it is difficult to receive and interpret data from disparate sources and to provide data to disparate users to serve disparate needs, all while maintaining appropriate data security.

### SUMMARY

This disclosure generally relates to implementing systems and methods. The methods comprise, by a computing system: receiving metadata for a data warehouse, the metadata comprising a plurality of data identifiers, each data identifier associated with a unique data item; receiving, from a plurality of incompatible data sources respectively via a plurality of first application programming interfaces, a plurality of datasets that each comprise at least one of the plurality of data identifiers (wherein each of the plurality of datasets has a data format different than data formats of all other ones of the plurality of datasets); transforming the data format of at least a portion of each one plurality of datasets into another data format based on the at least one of the plurality of data identifiers and or a respective one of the plurality of first application programming interfaces; storing, in a plurality of interconnected tables within the data warehouse, the plurality of datasets after said transforming; receiving, through each of a plurality of second application programming interfaces, a request for data, the request comprising at least one data identifier of the plurality of data identifiers; and returning, via each of the second application programming interfaces, analyzed or summarized data based on the at least one data identifier contained in the request and or a respective one of the plurality of second application programming interfaces.

The present document also concerns a system comprising: a processor; and a non-transitory computer-readable storage medium comprising programming instructions that are configured to cause the processor to implement a method for mitigating an effect of interference. The programming instructions comprise instructions to: receive metadata for a data warehouse, the metadata comprising a plurality of data identifiers, each data identifier associated with a unique data item; receive, from a plurality of incompatible data sources respectively via a plurality of first application programming interfaces, a plurality of datasets that each comprise at least one of the plurality of data identifiers, wherein each of the plurality of datasets has a data format different than data formats of all other ones of the plurality of datasets; transform the data format of at least a portion of each one plurality of datasets into another data format based on the at least one of the plurality of data identifiers and or a respective one of the plurality of first application programming interfaces; store, in a plurality of interconnected tables within the data warehouse, the plurality of datasets after said transforming; receive, through each of a plurality of second application programming interfaces, a request for data, the request comprising at least one data identifier of the plurality of data identifiers; and return, via each of the second application programming interfaces, analyzed or summarized data based on the at least one data identifier contained in the request and or a respective one of the plurality of second application programming interfaces.

### BRIEF DESCRIPTION OF THE DRAWINGS

This disclosure is facilitated by reference to the following drawing figures, in which like numerals represent like items throughout the figures.

FIGS. 1A-1B (collectively referred to as “FIG. 1”) provides an illustration of a system implementing the present solution.

FIG. 2 provides an illustration that is useful for understanding mapping identifiers of the present solution.

FIG. 3 provides an illustration that is useful for understanding how the mapping identifiers are used to connect tables in a data warehouse.

FIG. 4 provides illustrations showing automation and measurement subsets and a subset of data that is automatically assigned by the system.

FIG. 5 provides an illustration showing a table grid.

FIGS. 6-7 provide illustrations that are useful for understanding a vending machine system.

FIGS. 8-9 provide illustrations that are useful for understanding another vending machine system.

FIG. 10 provides a flow diagram of an illustrative method for operating a distributed vending machine system.

FIG. 11 provides a flow diagram of a method for operating distributed vending machine systems.

FIG. 12 provides an illustration showing internal hardware that may be included in any of the electronic components of the system(s) shown in FIGS. 1-5 and/or that may be used to implement the methods of FIGS. 10-11.

### DETAILED DESCRIPTION

It will be readily understood that the solution described herein and illustrated in the appended figures could involve a wide variety of different configurations. Thus, the following more detailed description, as represented in the figures, is not intended to limit the scope of the present disclosure but is merely representative of certain implementations in different scenarios. While the various aspects are presented in the drawings, the drawings are not necessarily drawn to scale unless specifically indicated.

Reference throughout this specification to features, advantages, or similar language does not imply that all the features and advantages that may be realized should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

In the drawings, like numerals indicate like elements throughout. Certain terminology is used herein for convenience only and is not to be taken as a limitation on the claims. The following describes various embodiments of the present invention. However, it should be understood, based on this disclosure, that the claims are not necessarily limited by the embodiments described herein.

Increasingly, business decisions rely on insights that are based on data analytics. That is, business data is carefully examined to identify patterns and/or trends that can inform the decisions. It is axiomatic that the greater amount of quality data that is available for analysis, the better informed the decisions will be. Furthermore, business data generally includes confidential information that should only be accessible to authenticated users, e.g., based on the user's role within the business or enterprise. Thus, there is a need for systems that facilitate the intake and organization of business data which also enforce role-based security procedures.

The present solution provides such a system. The system implements a tool that is a self-directed data infrastructure configured to focus on information and/or data gathering, which transforms and distributes data near real time for collection, analysis and use in controlling distributed vending machine systems and/or media systems. The system has an unlimited data warehouse with unlimited data input capabilities which allows permission-based users the ability to access and architect reports and data visuals. This consolidated data flow built between multiple organizational departments allows a singular access source that resolves miscommunication, time management, financial accuracy, historical reconciliation, legal review, decision making, open items, and the ability to expedite solutions and vending machine and/or media screen control, (re)configuration and/or maintenance.

The data infrastructure is a highly secure custom data collection solution that consumes multiple data streams, warehouses the information, and transforms the data for actionable purposes. The data infrastructure provides a one stop solution that merges multiple business divisions into a singular portal (e.g., accounting, legal, sales, business development, finance & reporting, analytics, customer service, warehouse management, engineering, vending machine maintenance, media system maintenance, and/or sub-contractors), allowing transparency and insight across an entire organization and their customers and/or partners. The infrastructure collects, silos, and filters data from multiple sources, connected with ID mapping tables, and allows the end user (with assigned permission) and systems the ability to visualize, extract, and/or process the data for decision making purposes. Given user permissions, they are granted access to multiple areas of the infrastructure, and monitored based on their role within the organization. Entended capabilities of the data infrastructure include, but are not limited to, artificial intelligence (AI) integration, personalization, human interaction, user hierarchy, usage metrics monitoring, shipping and tracking, part ordering, inventory insight, and/or intelligent vending machine and/or media system (re)configuration and/or control.

The data infrastructure generally comprises a external portal, an internal portal, an internal management portal, and a management feature. The external portal comprises an external analytical portal that allows clients visually immersive and interactive insight to the data that has been collected which pertains to the partner company. The internal portal comprises an internal analytical portal which provides coherent insight to all of the organizations data to help with decision making and forecasting. The internal management portal is configured to: allow the organization to manage between companies, property's, clients, and internal team; provide users with the ability to submit, review, or extract data from the data warehouse; and use the data submitted to generate a variety of reports. The data infrastructure may also be configured to apply role level security across the entire system. The system may use a single sign-on (SSO) mechanism where user identity is verified using an ID provider.

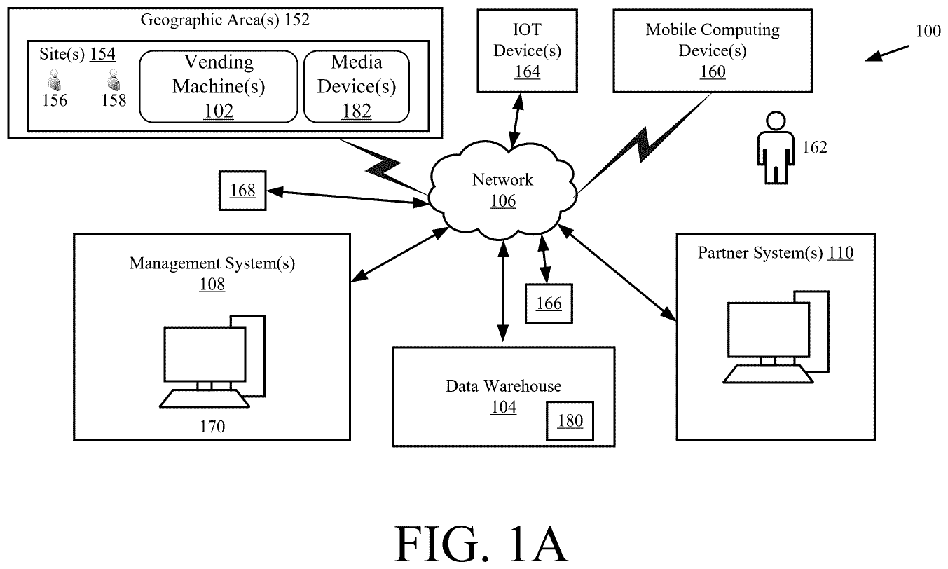

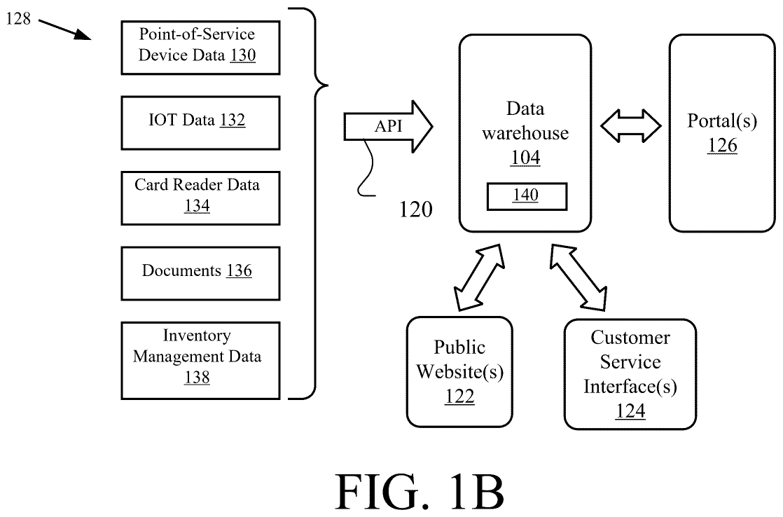

FIG. 1 provides an illustration of an environment comprising a distributed system 100. System 100 comprises vending machines 150 and/or media device(s) 182 that are located at one or more sites 154 in a geographic area 152. The sites may be private sites accessible only to authorized persons 156 and/or public sites accessible to members 158 of the public. The geographic area(s) can include, but is(are) not limited to, buildings, shopping or entertainment venues, city(ies), county(ies), state(s), and/or country(ies). The geographic areas may or may not be adjacent to one another. The vending machines 150 can include, but are not limited to, vending massage chairs, snack vending machines, stroller rental kiosks, and/or robotic systems (e.g., articulating arms of an automated restaurant or other business). The media device(s) 182 can include, but are not limited to, display screen(s), audio system(s), tactile output device(s) (e.g., vibrators), lighting system(s), sensor(s), and/or robotic system(s) (e.g., animatronics, and/or articulating arms). The sensor(s) can include, but are not limited to, proximity sensor(s), object detection sensor(s), light sensor(s), and/or environmental sensor(s). The media device(s) 182 can be free standing devices or part of the vending machine(s) 150. In the freestanding scenarios, the media device(s) 182 may be communicatively connected to the vending machine(s) 150 and/or be mounted on walls of a building. In the other scenario, the media device(s) 182 can be kiosk screens and/or massage chair vending screens. The media device(s) 182 can be interactive device(s). For example, the media device(s) 182 can include touch screen capabilities and/or the ability to identify an individual in proximity thereto (e.g., sitting in a massage chair or standing adjacent to a kiosk) to change the media display. The present solution is not limited to the particulars of this example.

During operation, the vending machine(s) 150 receive(s) information from user(s) 156, 158, process(es) the information for payment of vending service(s), and provide(s) paid-for and/or complimentary vending services to the user(s) 156, 158. The media device(s) 182 may also receive information from user(s) and/or output information to user(s). Operations of the vending machines 150 and/or media device(s) 182 may be autonomously performed and/or autonomously remotely controlled by a remote management system 108. The manner in which these autonomous operations are achieved will become evident as the discussion progresses.

Information received by the vending machines 150 and/or media device(s) 182 from the user(s) may be communicated to the management system 108 for further processing and/or a data warehouse 104 for storage. Other information may also be communicated between the components 150, 108, 104. This other information can include, but is not limited to, user input information, sensor data, configuration settings and/or data, control signals, commands, media (e.g., images, videos, music, etc.), lighting sequence(s), customer account information, and/or customer loyalty program information.

The vending machines 150, media device(s) 182 and/or management system 108 may also communicate with partner system(s) 110 to facilitate customer loyalty programs, customer account management, payment of vending service(s), inventory management, vending machine service and/or maintenance, ordering of vending machine part(s), document generation and management, advertisement, media output and/or streaming, real estate contract management, rental payment(s), accounting activities, human resource activities, and/or accounting report generation(s).

As shown in FIG. 1B, system 100 includes infrastructure directed to information/data gathering and analysis as well as filtering, transforming and distributing data in real-time or near real-time. The information may be related to a single business entity, or the information may be related to separate business entities or separate units, divisions, or departments within a business entity. System 100 also supports permission-based access to data for generating reports and visualizations (e.g., based on a user's authenticated role within a business entity and/or sub-unit within the business entity). The gathered data 128 can include, but is not limited to, point-of-service data 130, internet-of-thing (IOT) data 132, card reader data 134, document(s) 136, and/or inventory management data 138. The point-of-service device data 130 can include, but is not limited to, user ID, user account number, user preference(s), user selection(s), IDs for vending service(s) provided, vending service duration(s), timestamp(s), device fault(s), configuration data, and/or parameter settings or values. The IOT data 132 can include, but is not limited to, information specifying one or more of user ID(s), user account number(s), user preference(s), user selection(s), sensor data (e.g., personal health data and/or emotional data, image(s), recorded sound(s) and/or speech, heat signature(s) of living things, proximity sensor data, accessed website(s), product purchase(s), and output media. Card reader data can include, but is not limited to, customer account information and/or credit card information. Documents 136 can include, but are not limited to, real estate rental agreements, sub-contractor agreements, advertisement agreement(s), media use agreement(s), vending machine rental or purchase agreements, and/or vending machine maintenance agreement(s). Inventory management data 138 can include, but is not limited to, vending machine IDs, vending machine type(s), vending machine location(s), vending machine environmental data, vending machine status data, vending machine operation data, vending machine fault data, vending machine configuration data, vending machine parameter setting data, total number of vending machines, vending machine group numbers, and/or number of vending machines in a group and/or geographic area.

Accordingly, the data sources may include point-of-service devices such as vending machine system(s) 102 (which may include massage chair(s) and/or kiosk(s)), cash register(s), self-checkout system(s), software application running on mobile computing device(s) 160, and so forth. The data sources may also include IoT devices 164, that is, sensor-equipped objects including mobile communication devices, internet-connected sensors, internet-connected products, rental inventory, tracking tags, and the like. The data sources may further include credit/debit card readers or other sources of financial transaction information 166 (e.g., associated with purchase of goods or services), financial information associated with a business/division and/or information from various business units or organizational units, such as from financial management or accounting platforms of partner system(s) 110. The data sources may also include management system(s) 108 or other systems 168 which track, monitor and/or control assets owned by a business entity and/or division.

Data warehouse 104 collects information from these and other data sources, for example, through one or more application programming interfaces (APIs 120). The data warehouse 104 may also collect information through various other interfaces including, but not limited to, public-facing website(s) 122, customer-service interface(s) 124 (such as trouble-tracking and/or other feedback systems), and external portals 126. For example, portal 126 may provide for customers and/or business partners access to warehoused data for visually immersive and interactive insight to data within the data warehouse 104 that pertains to the customer or partner. Interfaces 124, 126 can include, but are not limited to, APIs.

Data warehouse 104 is configured to organize and manage the information received from these (and other) disparate data sources through varied interfaces, including interfaces 120, 122, 124, 126. In some examples, data warehouse 104 includes metadata for organizing the information. For example, data warehouse 104 may include data items (such as unique company names, regions, property names, property locations and/or addresses, property owners, asset types, etc.) that can serve to organize information. Each of these unique data elements may have an associated (unique) numeric identifier. These identifiers may be used to define relationships between different groups of related information (e.g., database tables 140) within data warehouse 104. Furthermore, the interfaces (e.g., APIs 120) to the data warehouse 104 may include identifiers, for example, to define relationships between information received through an interface 120-126 and information within the data warehouse 104. For example, information provided to the data warehouse 104 through an API 120 (or other interface 122-124) may be tagged with one or more identifiers to indicate how the information should be stored and/or associated with other information in the data warehouse 104. Furthermore, graphical interfaces of the data warehouse 104 may include pull-down menus or other graphical widgets whose contents may be populated by identifiers. For example, a pull-down menu may lists all the properties owned by a property owner, or all the asset types located at a particular property. The asset types can include, but are not limited to, types of vending machines (e.g., massage chair or stroller kiosk). The present solution is not limited in this regard.

An API 120 may be configured to filter and/or transform the information provided by a data source before the data is received by the data warehouse 104. For example, the APIs 120 may be configured to: (i) intelligently sort through and select some or all of the data received from each data source using machine learning model(s) and/or based on pre-defined rules (e.g., a rule stating that only certain types of data from a particular data source are to be filtered or extracted from a received dataset and selected for subsequent transformation); (ii) transform or otherwise convert the different data formats of the selected data into a uniform or common format; (iii) consolidate the transformed data (received from various, potentially incompatible software applications) into a consolidates dataset; and/or (iv) pass the consolidated dataset to the data warehouse 104. The data format transformation or conversion may include converting information from different data formats into the uniform or common format. The different data formats can be different in relation to one or more of the following features: human readable language, computer language, currency, numbering systems, units of measure, identifiers, product or service names, product or service descriptions, land descriptions, rental contract terms, relative data arrangements (e.g., in a packet or payload of an electronic message), metadata content, customer or partner identifiers and/or names, customer account information, loyalty program information, text format (e.g., plain text vs. encoded text), and/or encoding techniques (e.g., cryptographic algorithms). The transformation results in the transformed data having, for example, consistent units, currency, numbering, units of measure, language, identifiers and/or names, descriptions, data arrangement or format, and the like.

Machine learning models are well known in the art, and therefore will not be described in detail herein. Any known or to be known machine learning model can be used herein. For example, binary classification based machine learning models and/or clustering based machine learning models is(are) employed here. The machine learning models may be trained by the database warehouse 104 using some or all of the received data/information detect patterns in data received from the data sources and select or extract certain data from the received data based on the detected patterns. For example, a machine learning model may be trained to detect an order of types of data in a message payload, and extract portions of the payload that contain information of interest in accordance with a given application. The present solution is not limited in this regard.

The transformation is also configured to intelligently identify, select and transform only that information which is of interest and/or relevant to a given application or tasks. This feature of the present solution results in a less computationally intensive and less resource intensive system as compared to that of prior art systems. In this regard, it should be noted that this automated intelligent data collection and transformation feature of the present solution eliminates the need for the manual actions of (i) launching numerous disparate and/or incompatible software applications, (ii) accessing information of interest through graphical user interfaces (GUIs) and/or widgets of the launched software applications, (iii) consolidating the information into a GUI of another software application (e.g., an excel spreadsheet) in an organized and/or meaningful manner, (iv) analyzing the consolidated data and/or previously consolidated data (e.g., for previous days, weeks, months, and/or years) (e.g., to identify patterns therein), (v) generating reports based on the data analysis, (vi) updating customer accounts and/or loyalty program information based on the data analysis and/or reports, (vii) re-configuring and/or controlling operations of remote vending machines based on the data analysis and/or reports, (viii) scheduling service and/or maintenance of remote vending machines based on the data analysis and/or reports, (ix) updating contract terms (e.g., in relation to rental properties) based on the data analysis and/or reports, (x) managing rental agreements based on the data analysis and/or reports, and/or (xi) causing payments to be made to and/or by third parties (e.g., banks, credit card companies, advertiser(s), and/or media provider(s)) to customer(s) and/or partner(s).

APIs 120 may be configured to transform information in user-specific ways. For example, an API 120 may transform information according to established agreements, such as an established franchise agreement or other contract. The API 120 may transform data provided by the user according to terms of the contract. In one example, the API 120 may translate units of product sold or rented during a period of time into milestones toward satisfaction of an agreed-upon number of products sold or rented during the period of time. Transforming or filtering other data by the API 120 is also within the scope of this disclosure.

Data warehouse 104 may also include interfaces that provide access to the information. As previously disclosed, these interfaces may include portals 126. A portal 126 provides for an authenticated user to access (e.g., download and/or visualize) relevant information from the data warehouse 104. For example, portal 126 may provide an analysis or summary of relevant information, for example, in the form of reports, graphs, presentations, and the like. A report may combine IOT data related to a rental product with point-of-sales information related to the product to provide insights into how different customers use the product. This feature (and others) of the present solution results in less resource intensivity, computational complexity, shorter processing times, and improved user experience. In this regard, it should be understood that conventional systems require each of a plurality of users (which may be associated with different partners and/or customers) to (i) launch multiple disparate applications or websites to access respective data, (ii) identify data of interest from each data source, (iii) import/extract/download the data of interest from each data source, (iv) organize the data of interest from multiple data sources, and (vi) store the same in a datastore so as to be related to each other in a meaningful manner. The present solution eliminates the need for users to perform these steps. Since the multiple disparate applications do not need to launched and used by each user to search for data of interest using multiple different GUIs, the present solution provides improvements in relation to resource intensivity, computational complexity, processing times, and user experience,

Some or all interfaces to the data warehouse 104 include aspects of role-based security. That is, an interface may require a user to authenticate, for example, with a cloud-based identity and access-management platform. Role-based security verifies that the user is authorized to access and/or update information in the data warehouse 104.

Data warehouse 104 may support a vending solutions provider. In this example, data identifiers (IDs) may include, without limitation, a unique company ID associated with each line of business or each distinct business entity, a unique region ID associated with each geographical area in which a business operates, a unique property ID associated with each physical address at which a vending system is available, a unique location ID associated with the physical location of each vending system, unique IDs for each type of in-field rental assets (e.g., strollers, massage chairs, etc.), and an owner ID associated with the owner of each property. As information is received through an API 126, the information will have an associated identifier that indicates, for example, the vending location associated with the information. In this way, data warehouse 104 will properly associate the received information with the indicated vending location. Furthermore, based on the API 126 and/or identifier(s) associated with the information, the API 126 may transform or filter the information before the information is stored in the data warehouse 104. The transformation may be based on contractual terms, for example, with a particular property owner. The transformation may depend on the associated owner ID.

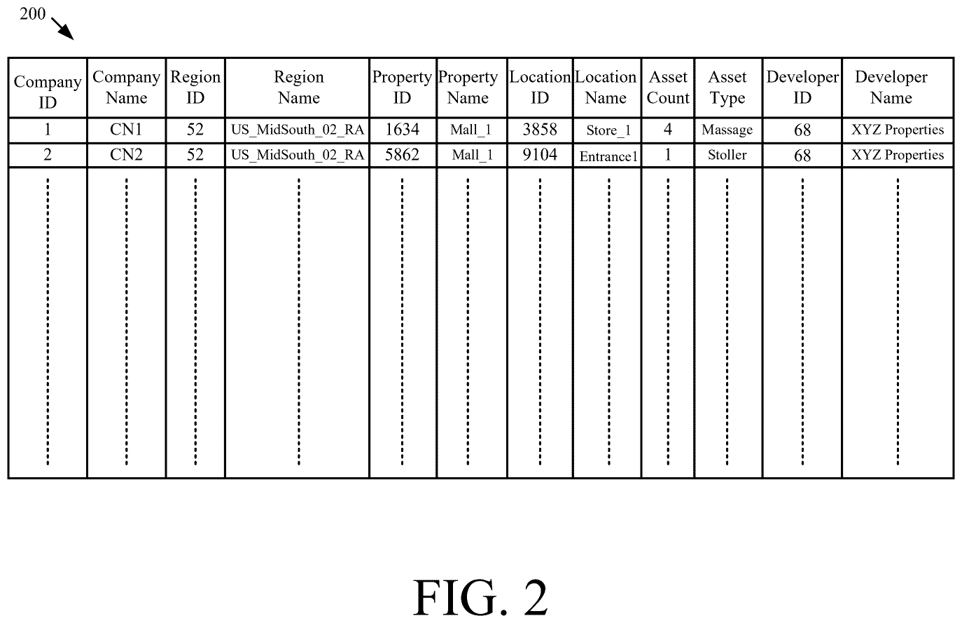

Illustrative mapping identifiers that are used by data warehouse 104 are shown in FIG. 2. Table 200 of FIG. 2 shows a small example of the mapping identifiers that are assigned by processor or computing device 180 of the data warehouse 104 per item. Everything logged into the data warehouse 104 is assigned a mapping ID. The mapping ID may be autogenerated and hardcoded. The item (property, region, developer, etc.) then becomes available in dropdown menus. When the system assigns these items to other attributes, it creates a grid that allows the system to build reports and analytics across the system's infrastructure. Mapping table 200 represents a mapping of entities against the same property and region. The mapping ID's are generated by processor 180 of the data warehouse 104, and then assigned throughout portals 126, allowing the data warehouse 104 to connect to all of the data sources.

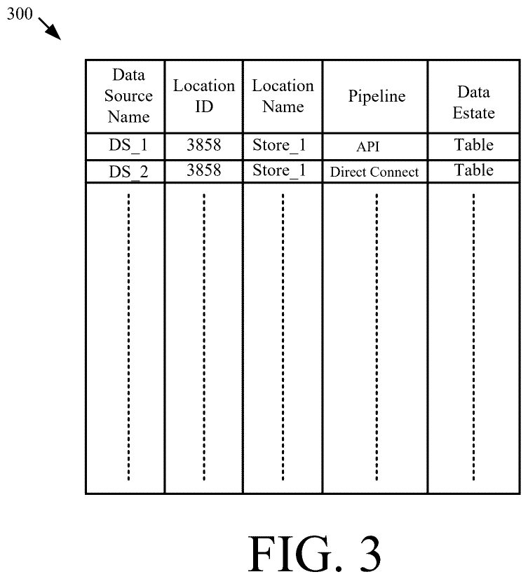

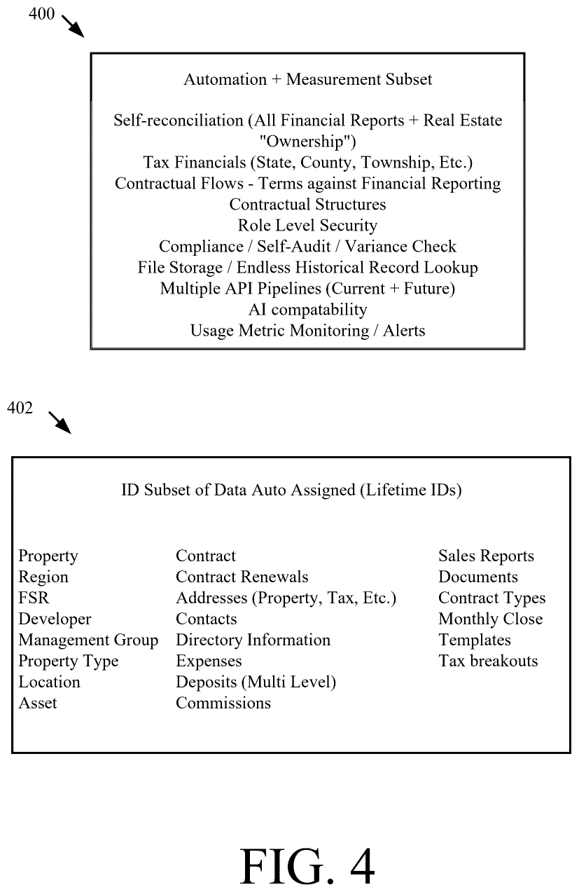

Another table 300 is shown in FIG. 3 that is useful for understanding how the mapping IDs are used to connect tables 140 in a data warehouse. Table 300 shows a small example of the ID's assigned per location in multiple sources that feed into the data warehouse 104. This allows processor 180 to connect tables 140 using the mapping ID's and depending on the cardinality of the connection, obtain all of the attributes associated therewith. Table 400 of FIG. 4 lists the types of data which may be included in an automation and measurement subset associated with an item. Table 402 of FIG. 4 lists the type of data in a subset of data that is automatically assigned by the processor 180 to each item.

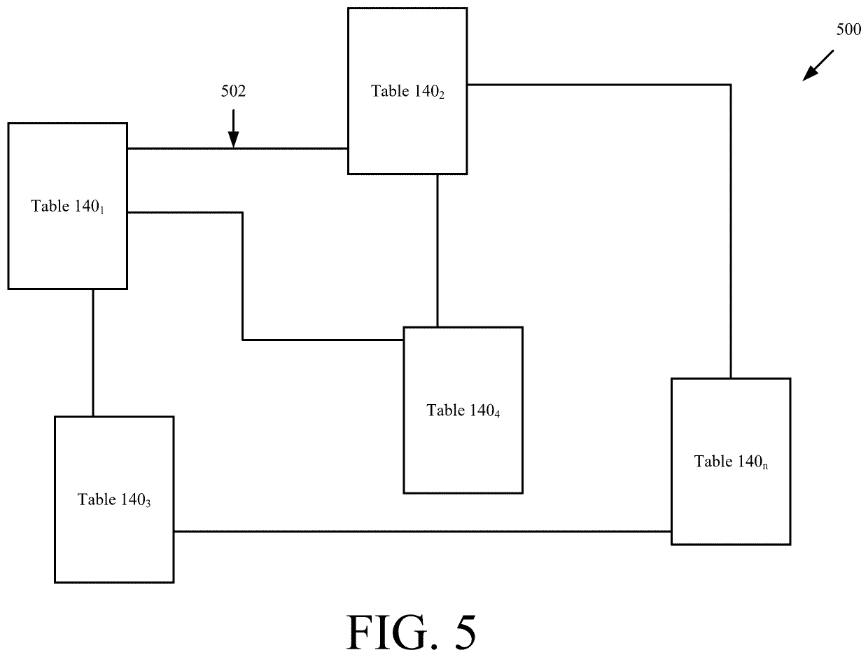

An illustrative table grid 500 is provided in FIG. 5 showing a plurality of tables 140₁, 140₂, 140₃, 140₄, . . . , 140n connected to each other based in mapping IDS. The 140₁es 140₁, 140₂, 140₃, 140₄, . . . , 140n are connected through the mapping structure via IDs (e.g., auto assigned ID's). The tables 140₁, 140₂, 140₃, 140₄, . . . , 140n may be accessed and retrieved from the data warehouse 104. Table relationships are built (table-to-table connections) with the ability to speak in multiple directions. For example, a table-to-table connection 502 is provided between tables 140₁ and 140₂. Data from table 140₂ may be obtained after table has been accessed 140₁, and vice versa. The present solution is not limited to the particulars of this example.

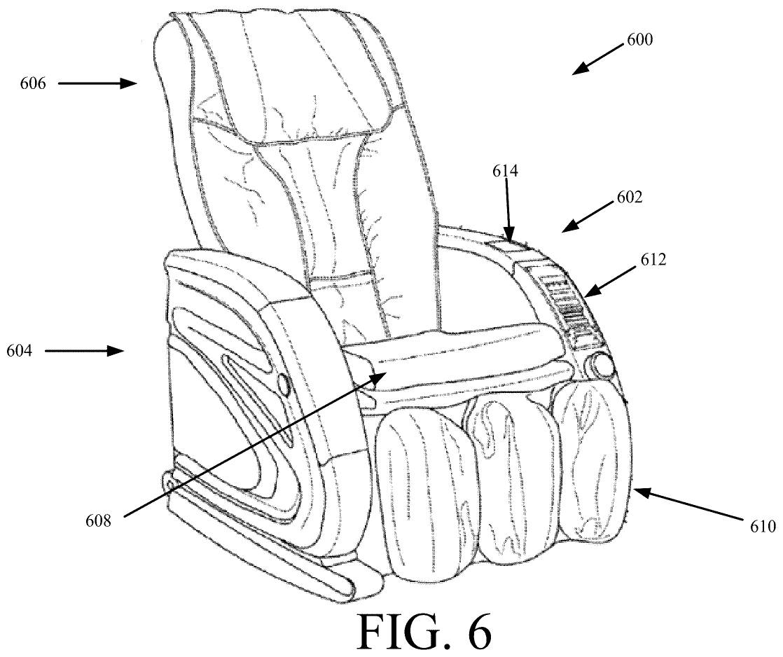

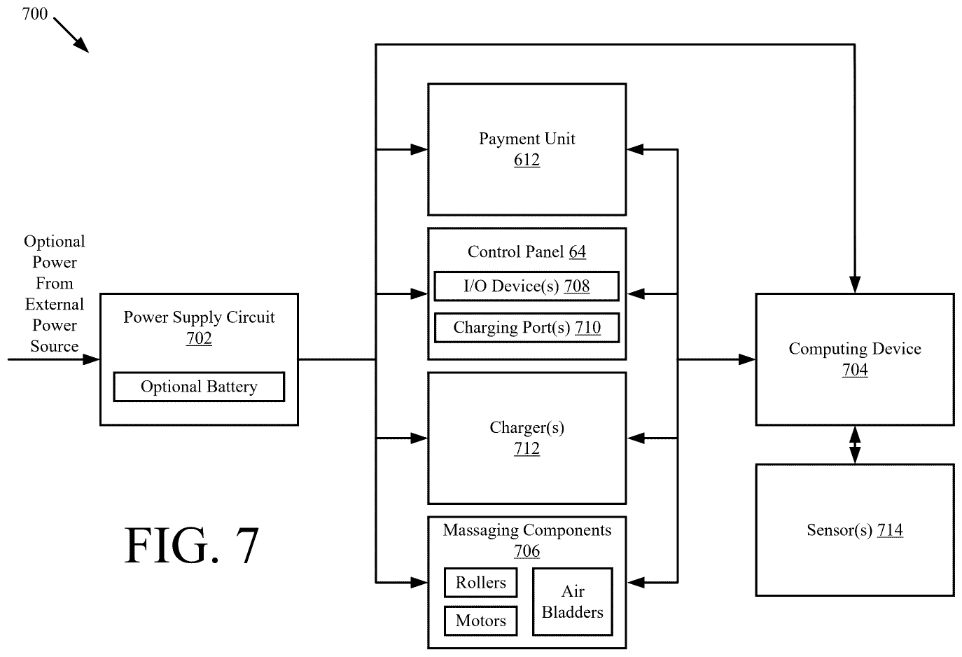

Data warehouse 104 may also support and/or facilitate vending machine management and/or media device management. In this regard, the data warehouse 104 may support, allow and/or facilitate autonomous remote control of vending machine operations and/or functions, and/or media device operations and/or functions. The vending machines can include, but are not limited to, vending massage chairs. Vending massage chairs are well known in the art. An illustrative vending message chair that may be employed here is described in U.S. Pat. No. 9,904,917 to Ruggiero et al. (“the '917 patent”). Illustrations of such an illustrative vending massage chair 200 are provided in FIGS. 6-7. The media device(s) can include, but is(are) not limited to, display device(s) shown in U.S. Design patent application Ser. No. 29/909,529 to Ruggiero et al. (“the '529 Application”). The display device(s) of the '529 Application may be used alone or with vending machines. Electronic advertisements and/or other media may be displayed on the display screen of the display device(s).

As shown in FIGS. 6-7, the vending massage chair 600 generally comprises two arm rests 602, 604, a back rest 606, a seat 608, a leg support 610, and an internal circuit 700. Massaging components 706 are provided in the back rest 606, the seat 608, and/or the leg support 610. The massaging components 706 are generally configured to mechanically provide a therapeutic manipulation of body tissue as part of a massaging service when the massaging components are enabled and the seat 608 is occupied by a user. In this regard, the massaging components 706 include motors, air bladders, rollers, hydro (or water based) massage components, and/or other mechanical tissue manipulators. Seat 308 is sized and shaped to allow the user to sit thereon so that his(her) body tissue is adjacent to the massaging components when the seat is occupied by the user. The massaging components may be enabled or otherwise activated when (i) a power source (e.g., AC mains and/or battery) has been electronically coupled to the vending massage chair 300, (ii) the presence of a seated user is detected by a sensor 714 of the vending massage chair 300, (iii) a successful payment transaction is performed for a massage service, and/or (iv) autonomously based on data stored in the data warehouse 104. Payment transactions are well known in the art, and therefore will not be described herein.

A payment unit 612 is at least partially disposed in an arm rest 602 of the vending massage chair 600. The payment unit 612 is generally configured to facilitate the payment transactions for the massage services and/or other services. The payment unit 612 may include, but is not limited to, a coin operated payment unit, a bill operated payment unit, and/or a card operated payment unit. Each of the list types of payment units is well known in the art, and therefore will not be described here.

A control panel 614 is also disposed in the arm rest 602 of the vending massage chair 600. The control panel 614 includes one or more Input and/or Output (I/O) devices 708 for controlling operations of the massaging components 706. Such I/O devices 708 can include, but is(are) not limited to, a keypad, a display screen, buttons and/or switches. The display screen may be a Liquide Crystal Display (LCD) and/or a touch screen display. The operations may include, but are not limited to, entering a customer identifier for retrieving pre-stored massage chair configuration preferences, turning a massaging component off, changing a speed of a massaging component, changing a location of the massaging component relative to the user's body, changing an amount of water pressure and/or flow speed of a hydro massage component, changing which hydro massage components are active/inactive, and/or adjusting an amount of air in an air bladder (e.g., disposed in the seat 608 and/or leg support 610).

Electronic advertisements and/or other media may be displayed on the display screen of the control panel 614 prior to, during and/or after provision of a massage service. The media may additionally or alternatively be output auditorily and/or tactically from the control panel 614. The I/O devices 708 may also be used by the user to select and/or change the advertisement and/or media content displayed on the display screen. For example, a user may be able to watch a particular video or may be able to listen to a particular song while (s)he receives a massage provided by the vending massage chair 600. The media feature of the vending massage chair 600 may be a complimentary feature or a paid-for feature. In some scenarios, a kiosk may additionally be attached to the vending massage chair 600 that has a display screen for presenting electronic advertisements and/or other media to a user of the vending massage chair 600. Additionally and/or alternatively, the advertisement and/or media content may be remotely and/or autonomously selected for output from the control panel 614 based on the data stored in the data warehouse 104.

The control panel 614 may additionally include one or more charging ports 710 (e.g., a Universal Serial Bus (USB) port) to facilitate charging of power sources contained in external electronic devices (e.g., portable computers and/or mobile phones) as part of a paid-for charging service or as part of a complimentary charging service when the external electronic device is connected to the vending massage chair 600 by the user. In the complimentary charging service scenarios, the charging port(s) 710 is(are) supplied power from charger(s) 712 only when the massaging component(s) 706 is(are) enabled as described in the '917 patent.

The vending massage chair 600 is optionally configured to cause movement of the massaging component(s) 706 to create discomfort at a user's back after the user has occupied the seat 608 for a threshold period of time without paying for a massage service, a charging service, and/or a media service. The effect of this optional discomfort feature is to make a user uncomfortable so the user does not linger in the chair without putting money in, and allows for more efficient marketing of the chair system for paying users. The program can be changed at any time if a situation warrants, for example, by extending a timer, by reducing intensity of a vibrating irritation means, or the like. In addition to rollers, knobs, irregularly positioned nodules, or large, rounded pins, for example, may be used to make the system uncomfortable for sitting, so the user does not linger in the chair without putting money in, and thereby freeing up the chair for a subsequent paying user. The system allows for changes to the timing requirement and intensity of the discomforting means.

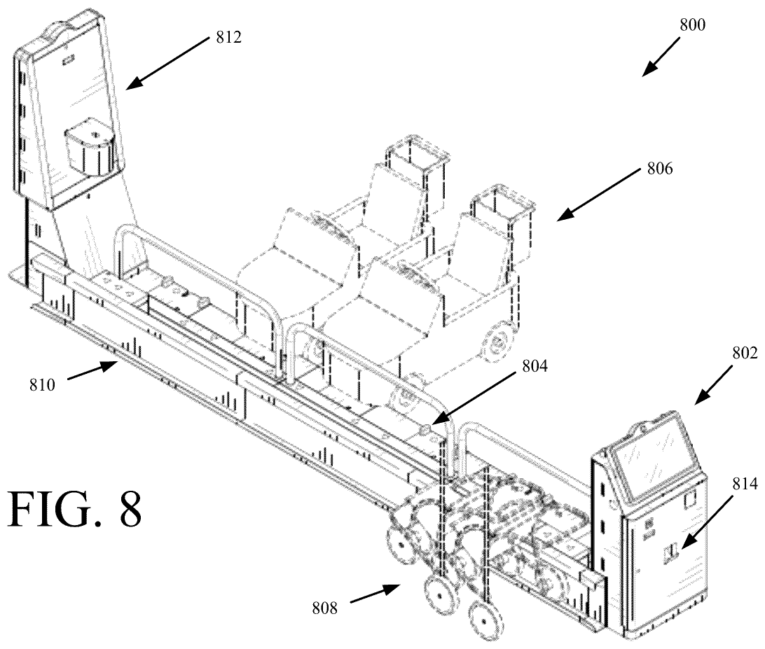

The vending machines can also include, but are not limited to, stroller vending systems. Stoller vending systems are well known in the art. One such stroller vending system 800 is shown in FIG. 8. The stroller vending system 800 comprises a kiosk 802, a media terminal 812, and a stroller storage unit 810 disposed between kiosk 802 and media terminal 812. Kiosk 802 is generally configured to facilitate rental of stroller(s) 806. Kiosk 802 can include, but is not limited to, a keypad, a display screen, button(s), switch(es), speaker(s), vibrator(s), processor(s), datastore(s), system interface(s), and/or communication device(s). The listed components of kiosk 802 may be configured to facilitate entering a customer identifier for retrieving customer account information and/or stroller configuration preferences. Each stroller may have one or more features that can be (re)configured in accordance with the stroller configuration preferences and/or based on the data stored in data warehouse 104. These features can include, but are not limited to, media output, lighting sequence(s) and/or color(s), noise(s), and/or speaker volume. Each stroller 806 may be mechanically secured to the stroller storage mechanism 810, for example, via latches, tracks, and/or electro-mechanical locks 804. The kiosk 802 may cause actuation of the electro-mechanical locks 804 upon a successful payment for stroller rental and/or other criteria being met.

Certain operations of the kiosk 802 may be activated when (i) a power source (e.g., AC mains and/or battery) has been electronically coupled to the stroller vending system 800, (ii) the presence of a person is detected by a sensor of the stroller vending system 800, and/or (iii) a successful payment transaction is performed for stroller rental. Payment transactions are well known in the art, and therefore will not be described herein. A payment unit 814 is at least partially disposed in kiosk 802. The payment unit 814 is generally configured to facilitate the payment transactions for stroller rental and/or other services. The payment unit 814 may include, but is not limited to, a coin operated payment unit, a bill operated payment unit, and/or a card operated payment unit. Each of the list types of payment units is well known in the art, and therefore will not be described here.

Electronic advertisements and/or other media may be displayed on the display screen of the media terminal 812 and/or kiosk 802 at any time. Media may additionally or alternatively be output auditorily and/or tactilely from the media terminal 812 and/or kiosk 802. The advertisement and/or media content may be remotely and/or autonomously selected for output from the media terminal 812 and/or kiosk 802 based on the data stored in the data warehouse 104. For example, a particular video may be viewed and/or a particular song may be output from the media terminal 812 during operating hours of the business (e.g., a mall or airport) when the kiosk 802 detects the presence of one or more persons in proximity thereto. The media content and/or output criteria may be autonomously (re)configured and/or controlled remotely by the management system(s) 108 based on an analysis of and/or reports generated based on data stored in the data warehouse 104. Specifically, operations of the media terminal 812 and/or kiosk 802 are autonomously remotely controlled to output a particular advertisement of a plurality of advertisements which data analytics has shown (i) to have relatively positive effects on the emotions of previous users of the stroller vending system (as detected by sensors of the media terminal 412 and/or kiosk 802) and/or (ii) that users of the stroller vending system accessed a website associated with the advertisement and/or ordered products associated with the advertisement. The present solution is not limited to the particulars of this example.

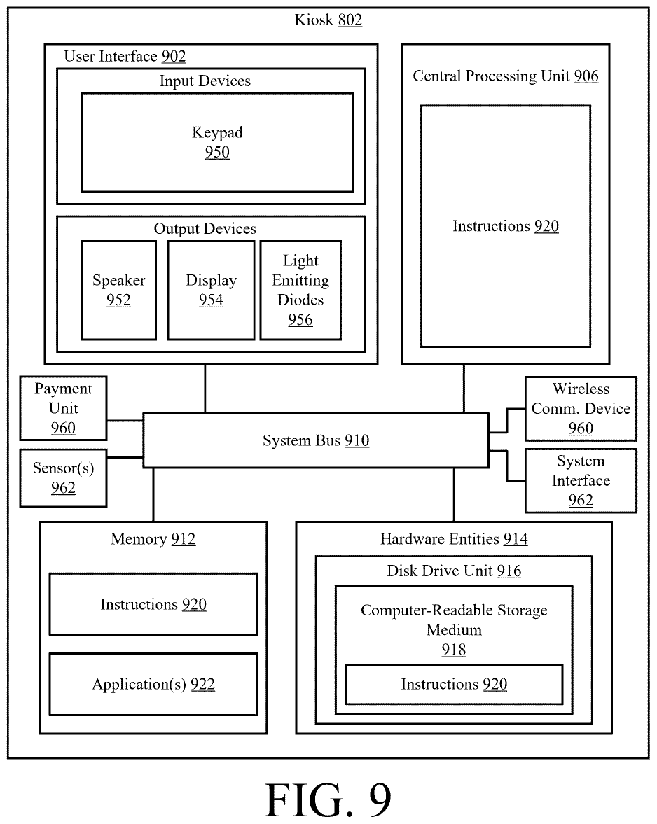

FIG. 9 shows an illustrative architecture for kiosk 802. Kiosk 802 may include more or less components than those shown in FIG. 9. However, the components shown are sufficient to disclose an illustrative embodiment implementing the present solution. The hardware architecture of FIG. 9 represents one embodiment of a representative kiosk configured to facilitate the control of the stroller vending system 800 for improved customer experiences and/or satisfaction. As such, kiosk 802 of FIG. 8 implements at least a portion of the methods described herein for operational control of a stroller vending system 800.

Some or all the components of kiosk 802 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

Kiosk 802 comprises a user interface 902, a CPU 906, a system bus 910, a memory 912 connected to and accessible by other portions of kiosk 802 through system bus 910, and hardware entities 914 connected to system bus 910. Various information can be stored in memory 912. Such information includes, but is not limited to, total credits since last reset, a total lifetime credits, a payment device credits since last reset, a payment device lifetime credits, phone application credits since last reset and/or phone app lifetime credits. The user interface can include input devices (e.g., a keypad 950) and output devices (e.g., speaker 952, a display 954 (e.g., a LCD display), and/or light emitting diodes 956), which facilitate user-software interactions for controlling operations of the stroller vending system 800. Audio can be output from speaker 952 prior to, during, and/or subsequent to the provision of a vending service.

Stroller identifiers may be displayed on the display 954. Each stroller identifiers can include one or more letters, number, symbols, and/or image(s). The stroller identifiers are provided to facilitate the selection and release of a stroller from the stroller storage unit 410.

At least some of the hardware entities 914 perform actions involving access to and use of memory 912, which can be a Random Access Memory (RAM). Hardware entities 914 can include a disk drive unit 916 comprising a computer-readable storage medium 918 on which is stored one or more sets of instructions 920 (e.g., software code) configured to implement one or more of the methodologies, procedures, or functions described herein. The instructions 920 can also reside, completely or at least partially, within the memory 912 and/or within the CPU 906 during execution thereof by the kiosk 802. The memory 912 and the CPU 906 also can constitute machine-readable media. The term “machine-readable media”, as used here, refers to a single medium or multiple media (e.g., a centralized or distributed database, and/or associated caches and servers) that store the one or more sets of instructions 920. The term “machine-readable media”, as used here, also refers to any medium that is capable of storing, encoding or carrying a set of instructions 920 for execution by the kiosk 802 and that cause the kiosk 802 to perform any one or more of the methodologies of the present disclosure.

In some scenarios, the hardware entities 914 include an electronic circuit (e.g., a processor) programmed for facilitating the user control and/or autonomous control of vending machine operations. In this regard, it should be understood that the electronic circuit can access and run a software application 922 installed on the kiosk 802.

A wireless communication device 960 and/or a system interface 962 may also be provided with the kiosk 802. The wireless communication device 960 is configured to facilitate wireless communications between the stroller vending machine 800 and external devices (e.g., a remote server and/or mobile communication devices). The wireless communications can include, but are not limited to, near field communications (NFCs), and/or short range communications (SRCs) (e.g., WiFi and/or Bluetooth). The system interface 962 is configured to facilitate wired communications between the stroller vending machine 800 and external devices (e.g., mobile communication devices). In this regard, the system interface 962 can include, but is not limited to, an Ethernet interface and/or a USB interface. The interface(s) 960, 962 can be used to report diagnostic information, usage patterns and/or other information to the remote data warehouse 102, a server 170 of a management system 108 and/or mobile communication device(s) 160 of field service representative(s). The diagnostic information reporting can be achieved via electronic messages (e.g., electronic mail messages and/or text massages). Settings of the stroller vending machine 800 can be remotely controlled and/or adjusted the management system 108, data warehouse 104, an administrator using the remote server 170, and/or a field service representative using a mobile communication device 160.

The diagnostic information can include, but is not limited to, information indicating that there is no communication to a mother control board, there is no AC to a logic supply, electromechanical coupler fault has been detected, motor fault has been detected, a payment device fault occurred, power cycle count, computer reset count, error codes, temperature data, and/or stroller state data. The diagnostic information can be reported continuously, periodically (e.g., three times a day) at pre-defined times, and/or responsive to trigger events. The trigger events can include, but are not limited to, a powering on of the stroller vending machine, a transition to a maintenance mode, a clearing of transaction totals, and/or a transition from the maintenance mode.

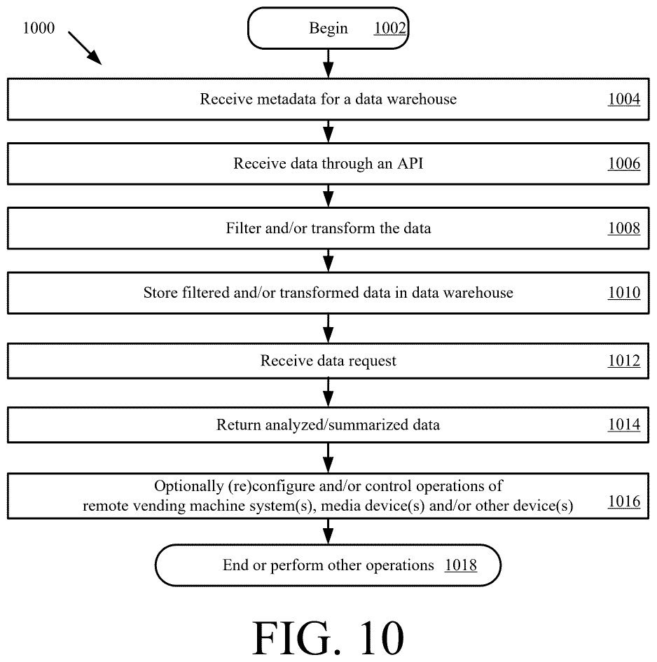

FIG. 10 provides a flow diagram of an illustrative method 1000 of managing data in data warehouse 104. Method 1000 may be implemented in system 100 discussed above. Operations of blocks 1002-1012 may be performed in the same or different order than shown.

Method 1000 begins with block 1002 and continues to block 1004 where a processor (e.g., processor 180 of FIG. 1) receives metadata for data warehouse 104. The metadata may include, but is not limited to, data identifiers. Each of the data identifiers may be associated with a unique data item in the data warehouse 104. For example, each type of asset or inventory made has a unique, numeric identifier and/or a unique label.

In block 1006, the processor receives, through one of multiple application programming interfaces (APIs 120), data to be warehoused. The received data can include, but is not limited to, at least one of the data identifiers. The received data may also include point-of-service device data 130, IOT date 132, card reader data 134, document(s) 136, and/or inventory management data 138.

In block 1008, the processor filters and/or transforms the received data based on the received at least one data identifier and/or the API 120. For example, the data may be transformed according to terms of a contract with a particular vendor, property owner, etc. The data may be associated with an identifier that indicates the vendor and/or owner, and therefore indicates the contract (and applicable terms). The API 120 may transform the received data according to the identified contract terms.

In block 1010, the processor stores the filter and/or transformed data in the data warehouse 104, where it can be accessed through other interfaces, such as a portal 126.

In block 1012, the processor receives, through other interfaces, requests for the data, each request including at least one data identifier. That is, the portal 126 and other interfaces allow authenticated users to access information in the data warehouse 104. To identify relevant data, the user provides an identifier that indicates the information of interest.

In block 1014, the processor returns (via the interface) analyzed or summarized data based on the interface and/or the identifier. For example, the interface may be a GUI through which a user requests financial information, and which displays the requested financial information in graphical form. The interface may support generating reports based on identified data to provide insights into business operations. The interfaces may also implement role-based authentication so that only authorized users may access sensitive information.

In block 1016, the processor may optionally perform operations to (re)configure and/or control operations of remote vending machine systems 102, media devices 152 and/or other device(s) based on the analyzed and/or summarized data. For example, the processor may communicate with a computing device (e.g., computing device 704 of a vending machine or media device to: (re)configure media settings and/or vending service settings in accordance with contents of the analyzed and/or summarized data (e.g., particular media is to be output when the data shows a correlation between it and vending sales, or a particular massage service or stroller type is to be provided when the data shows a correlation between it and customer's health benefits and/or emotional states which may have been previously detected using sensors of the vending machine system); and/or autonomously enable or otherwise control operations of the vending machine system to provide the vending service or vended product (e.g., stroller or snack) based on the contents of the analyzed and/or summarized data (e.g., massaging components 706 are enabled to provide a massage service that focuses on a particular part of a person's body when the analyzed and/or summarized data shows that this is a relatively popular message service in a given customer demographic or geographic area 152 and/or a total revenue associated therewith exceeds a threshold, and/or a coupling mechanism 804 is actuated to release a particular stroller of a plurality of different strollers when the analyzed and/or summarized data indicates that this particular stroller was recently serviced, meets customer preferences and/or is historically a popular or the most user-selected of all strollers being currently stored by the stroller vending system). Subsequently, method 1000 continues to block 1018 where it ends or other operations are performed.

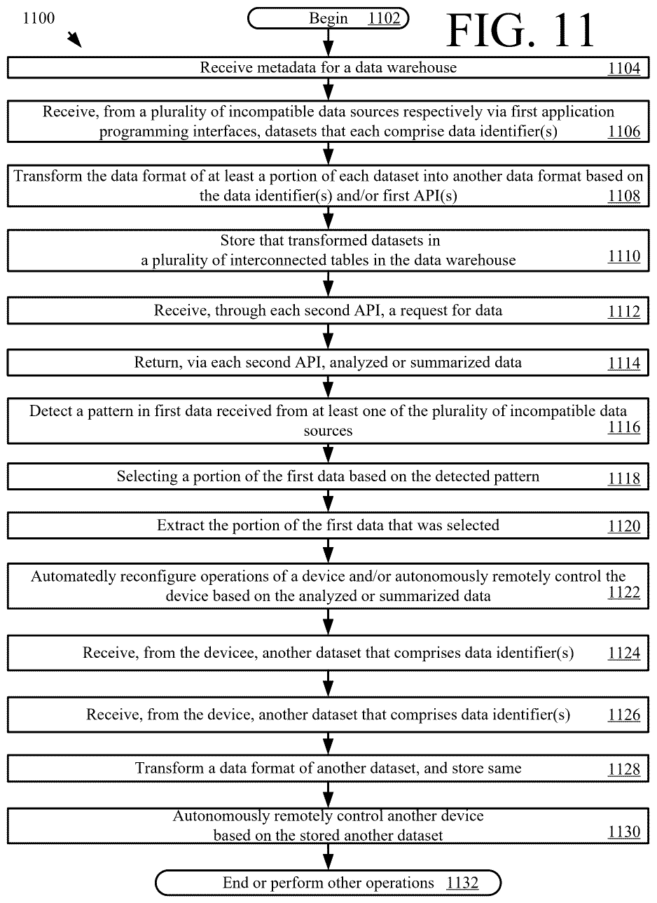

FIG. 11 provides a flow diagram of a method 1100 for operating a computing system (e.g., system 100 of FIG. 1, and/or processor or computing device 180 of FIG. 1). Method 1100 begins at block 1102 and continues to block 1104 where the computing system receives metadata for a data warehouse (e.g., data warehouse 104 of FIG. 1). The metadata comprises data identifiers. Each data identifier is associated with a unique data item. Block 1104 can involve receiving unique numeric identifiers.

Next in block 1106, the computing system receives, from a plurality of incompatible data sources (e.g., data sources 102, 110, 160, 164, 166 and/or 168 of FIG. 1), respectively via first APIs (e.g., APIs 120 of FIG. 2), datasets (e.g., datasets 130, 132, 134, 136 and/or 138 of FIG. 2) that each comprise at least one of the data identifiers. Each dataset has a data format different than data formats of all other ones of the plurality of datasets. Different data formats are known. Any known or to be known data format can be used here.

In block 1108, the computing system transforms the data format of at least a portion of each dataset into another data format based on the data identifier(s) and/or a respective one of the first APIs. The transformation of the data format may be based on terms of a contract. The computing system stores the transformed datasets in a plurality of interconnected tables (e.g., tables 140₁, . . . ,140ₙ of FIG. 5) within the data warehouse, as shown by block 1110.

In block 1112, the computing device receives, through each of a plurality of second APIs (e.g., interfaces 122, 124 and/or 126 of FIG. 1), a request for data. The request comprises at least one of the data identifiers. Block 1112 can involve receiving credentials that authorize returning the analyzed or summarized data, and/or receiving credentials generated by a role-based authentication system. The computing device returns, via each of the second application programming interfaces, analyzed or summarized data based on the at least one data identifier contained in the request and/or a respective one of the second APIs, as shown by block 1114. A graphical summary of the requested data may be generated in block 1114.

Next on blocks 1116-1120, the computing system: detects a pattern in first data received from at least one of the plurality of incompatible data sources; selects a portion of the first data based on the detected pattern; and extracts the portion of the first data that was selected.

In blocks 1122-1128, the computing system: automatedly reconfigures operations of a device (e.g., vending machine 102 of FIG. 1 and/or media device 182 of FIG. 1) based on the analyzed or summarized data; and/or autonomously remotely controlling operations of the device (e.g., the vending machine and/or media device) based on the analyzed or summarized data; receives, from the device (e.g., the vending machine and/or media device) via a respective interface of the first APIs, another dataset that comprises one or more data identifiers of the plurality of data identifiers; transforming a data format of another dataset into the another data format based on the one or more data identifiers and/or the respective interface of the plurality of first application programming interfaces; storing, in the plurality of interconnected tables within the data warehouse, the another dataset in the another data format; and autonomously remotely controlling another device (e.g., another vending machine and/or media device) based on the stored another dataset. Subsequently, method 1100 continues to block 1132 where it ends or other operations are performed.

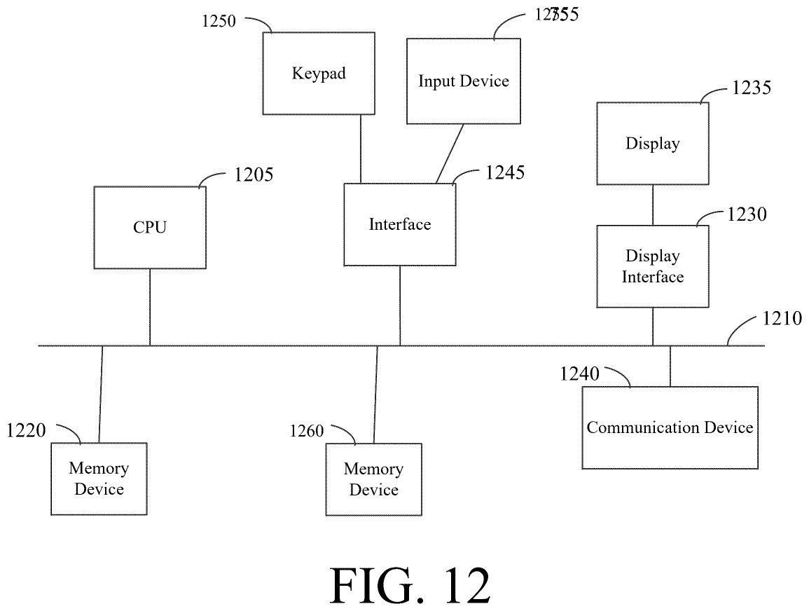

FIG. 12 depicts an example of internal hardware that may be included in any of the electronic components of the system 100. An electrical bus 1210 serves as an information highway interconnecting the other illustrated components of the hardware. Processor 705 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as CPU, a graphics processing unit (GPU), a remote server, or a combination of these. ROM, RAM, flash memory, hard drives and other devices capable of storing electronic data constitute examples of memory devices 1260. A memory device may include a single device or a collection of devices across which data and/or instructions are stored.

An optional display interface 1230 may permit information from the bus 1210 to be displayed on a display device 1235 in visual, graphic or alphanumeric format. An audio interface and audio output (such as a speaker) also may be provided. Communication with external devices may occur using various communication devices 1240 such as a wireless antenna, a radio frequency identification (RFID) tag and/or short-range or near-field communication transceiver, each of which may optionally communicatively connect with other components of the device via one or more communication system. The communication device 1240 may be configured to be communicatively connected to a communications network, such as the Internet, a local area network or a cellular telephone data network.

The hardware may also include a user interface sensor 1245 that allows for receipt of data from input devices 1255 such as a keyboard 1250, a mouse, a joystick, a touchscreen, a touch pad, a remote control, a pointing device and/or microphone. Digital image frames also may be received from a camera that can capture video and/or still images, such as a high-definition camera that incorporated into the user electronic device.

In view of the forgoing discussion, the present solution concerns implementing systems and methods comprising, by a computing system: receiving metadata for a data warehouse, the metadata comprising a plurality of data identifiers, each data identifier associated with a unique data item; receiving, from a plurality of incompatible data sources respectively via a plurality of first application programming interfaces, a plurality of datasets that each comprise at least one of the plurality of data identifiers (wherein each of the plurality of datasets has a data format different than data formats of all other ones of the plurality of datasets); transforming the data format of at least a portion of each one plurality of datasets into another data format based on the at least one of the plurality of data identifiers and or a respective one of the plurality of first application programming interfaces; storing, in a plurality of interconnected tables within the data warehouse, the plurality of datasets after said transforming; receiving, through each of a plurality of second application programming interfaces, a request for data, the request comprising at least one data identifier of the plurality of data identifiers; and returning, via each of the second application programming interfaces, analyzed or summarized data based on the at least one data identifier contained in the request and or a respective one of the plurality of second application programming interfaces.

The receiving metadata for the data warehouse may comprise receiving unique numeric identifiers. The receiving the request for data may comprise receiving credentials that authorize returning the analyzed or summarized data. The receiving the credentials may comprise receiving credentials generated by a role-based authentication system. The transforming the data format may be based on terms of a contract. The returning analyzed or summarized data may comprise generating a graphical summary of the requested data.

The methods may also comprise: detecting a pattern in first data received from at least one of the plurality of incompatible data sources; selecting a portion of the first data based on the detected pattern; extracting the portion of the first data that was selected; automatedly reconfiguring operations of a vending machine based on the analyzed or summarized data; autonomously remotely controlling operations of a vending machine based on the analyzed or summarized data; receiving, from the vending machine via a respective interface of the plurality of first application programming interfaces, another dataset that comprises one or more data identifiers of the plurality of data identifiers; transforming a data format of another dataset into the another data format based on the one or more data identifiers and or the respective interface of the plurality of first application programming interfaces; storing, in the plurality of interconnected tables within the data warehouse, the another dataset in the another data format; and/or autonomously remotely controlling another vending machine based on the stored another dataset.

The present solution also concerns a system comprising: a processor; and a non-transitory computer-readable storage medium comprising programming instructions that are configured to cause the processor to implement a method for mitigating an effect of interference. The programming instructions comprise instructions to: receive metadata for a data warehouse, the metadata comprising a plurality of data identifiers, each data identifier associated with a unique data item; receive, from a plurality of incompatible data sources respectively via a plurality of first application programming interfaces, a plurality of datasets that each comprise at least one of the plurality of data identifiers (wherein each of the plurality of datasets has a data format different than data formats of all other ones of the plurality of datasets); transform the data format of at least a portion of each one plurality of datasets into another data format based on the at least one of the plurality of data identifiers and or a respective one of the plurality of first application programming interfaces; store, in a plurality of interconnected tables within the data warehouse, the plurality of datasets after said transforming; receive, through each of a plurality of second application programming interfaces, a request for data, the request comprising at least one data identifier of the plurality of data identifiers; and return, via each of the second application programming interfaces, analyzed or summarized data based on the at least one data identifier contained in the request and or a respective one of the plurality of second application programming interfaces.

The metadata for the data warehouse may comprise unique numeric identifiers. The request for data may comprise credentials that authorize returning the analyzed or summarized data. The credentials may comprise credentials generated by a role-based authentication system. The data format may be transformed based on terms of a contract. The analyzed or summarized data may comprise a graphical summary of the requested data.

The programming instructions may also comprise instructions to: detect a pattern in first data received from at least one of the plurality of incompatible data sources; select a portion of the first data based on the detected pattern; extract the portion of the first data that was selected; automatedly reconfigure operations of a device (e.g., a vending machine and/or media device) based on the analyzed or summarized data; autonomously remotely control operations of a device (e.g., a vending machine and/or media device) based on the analyzed or summarized data; receive, from the device (e.g., the vending machine and/or media device) via a respective interface of the plurality of first application programming interfaces, another dataset that comprises one or more data identifiers of the plurality of data identifiers; transform a data format of another dataset into the another data format based on the one or more data identifiers and or the respective interface of the plurality of first application programming interfaces; store, in the plurality of interconnected tables within the data warehouse, the another dataset in the another data format; and/or autonomously remotely control another device (e.g., another vending machine and/or media device) based on the stored another dataset.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions, such as a microprocessor or other logical circuit. A processor and memory may be elements of a microcontroller, custom configurable integrated circuit, programmable system-on-a-chip, or other electronic device that can be programmed to perform various functions. Except where specifically stated otherwise, the singular term “processor” or “processing device” is intended to include both single-processing device embodiments and embodiments in which multiple processing devices together or collectively perform a process.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

What is claimed is:

1. A method comprising, by a computing system:
receiving metadata for a data warehouse, the metadata comprising a plurality of data identifiers, each data identifier associated with a unique data item;
receiving, from a plurality of incompatible data sources respectively via a plurality of first application programming interfaces, a plurality of datasets that each comprise at least one of the plurality of data identifiers, wherein each of the plurality of datasets has a data format different than data formats of all other ones of the plurality of datasets;
transforming the data format of at least a portion of each one plurality of datasets into another data format based on the at least one of the plurality of data identifiers and or a respective one of the plurality of first application programming interfaces;
storing, in a plurality of interconnected tables within the data warehouse, the plurality of datasets after said transforming;
receiving, through each of a plurality of second application programming interfaces, a request for data, the request comprising at least one data identifier of the plurality of data identifiers; and
returning, via each of the second application programming interfaces, analyzed or summarized data based on the at least one data identifier contained in the request and or a respective one of the plurality of second application programming interfaces.

2. The method according to claim 1, wherein receiving metadata for the data warehouse comprises receiving unique numeric identifiers.

3. The method according to claim 1, wherein receiving the request for data comprises receiving credentials that authorize returning the analyzed or summarized data.

4. The method according to claim 3, wherein receiving the credentials comprise receiving credentials generated by a role-based authentication system.

5. The method according to claim 1, wherein the transforming the data format is based on terms of a contract.

6. The method according to claim 1, wherein returning analyzed or summarized data comprises generating a graphical summary of the requested data.

7. The method according to claim 1, further comprising:
detecting a pattern in first data received from at least one of the plurality of incompatible data sources;
selecting a portion of the first data based on the detected pattern; and
extracting the portion of the first data that was selected.

8. The method according to claim 1, further comprising automatedly reconfiguring operations of a vending machine or media device based on the analyzed or summarized data.

9. The method according to claim 1, further comprising autonomously remotely controlling operations of a vending machine or media device based on the analyzed or summarized data.

10. The method according to claim 9, further comprising:
receiving, from the vending machine or media device via a respective interface of the plurality of first application programming interfaces, another dataset that comprises one or more data identifiers of the plurality of data identifiers;
transforming a data format of another dataset into the another data format based on the one or more data identifiers and or the respective interface of the plurality of first application programming interfaces; and
storing, in the plurality of interconnected tables within the data warehouse, the another dataset in the another data format.

11. The method according to claim 9, further comprising autonomously remotely controlling another vending machine or media device based on the stored another dataset.

12. A system, comprising:
a processor;
a non-transitory computer-readable storage medium comprising programming instructions that are configured to cause the processor to implement a method for mitigating an effect of interference, wherein the programming instructions comprise instructions to:
receive metadata for a data warehouse, the metadata comprising a plurality of data identifiers, each data identifier associated with a unique data item;
receive, from a plurality of incompatible data sources respectively via a plurality of first application programming interfaces, a plurality of datasets that each comprise at least one of the plurality of data identifiers, wherein each of the plurality of datasets has a data format different than data formats of all other ones of the plurality of datasets;
transform the data format of at least a portion of each one plurality of datasets into another data format based on the at least one of the plurality of data identifiers and or a respective one of the plurality of first application programming interfaces;
store, in a plurality of interconnected tables within the data warehouse, the plurality of datasets after said transforming;
receive, through each of a plurality of second application programming interfaces, a request for data, the request comprising at least one data identifier of the plurality of data identifiers; and
return, via each of the second application programming interfaces, analyzed or summarized data based on the at least one data identifier contained in the request and or a respective one of the plurality of second application programming interfaces.

13. The system according to claim 12, wherein the metadata for the data warehouse comprises unique numeric identifiers.

14. The system according to claim 12, wherein the request for data comprises credentials that authorize returning the analyzed or summarized data.

15. The system according to claim 14, wherein the credentials comprise credentials generated by a role-based authentication system.

16. The system according to claim 21, wherein the data format is transformed based on terms of a contract.

17. The system according to claim 12, wherein the analyzed or summarized data comprises a graphical summary of the requested data.

18. The system according to claim 12, wherein the programming instructions comprise instructions to:
detect a pattern in first data received from at least one of the plurality of incompatible data sources;
select a portion of the first data based on the detected pattern; and
extract the portion of the first data that was selected.

19. The system according to claim 12, wherein the programming instructions comprise instructions to automatedly reconfigure operations of a vending machine or media device based on the analyzed or summarized data.

20. The system according to claim 12, wherein the programming instructions comprise instructions to autonomously remotely control operations of a vending machine or media device based on the analyzed or summarized data.

21. The system according to claim 20, wherein the programming instructions comprise instructions to:
receive, from the vending machine or media device via a respective interface of the plurality of first application programming interfaces, another dataset that comprises one or more data identifiers of the plurality of data identifiers;
transform a data format of another dataset into the another data format based on the one or more data identifiers and or the respective interface of the plurality of first application programming interfaces; and
store, in the plurality of interconnected tables within the data warehouse, the another dataset in the another data format.

22. The system according to claim 21, wherein the programming instructions comprise instructions to autonomously remotely control another vending machine or media device based on the stored another dataset.
